(19) United States
(12) Patent Application Publication
(10) Pub. No.: US 2008/0155506 A1
(43) Pub. Date: Jun. 26, 2008

(54) XML export from and import into a debugger

(75) Inventor: Srdjan Boskovic, Walldorf (DE)

Correspondence Address: SCHWEGMAN, LUNDBERG & WOESSNER/SAP, P.O. BOX 2938, MINNEAPOLIS, MN, 55402, US

(73) Assignee: SAP AG

(21) Appl. No.: 11/644,173

(22) Filed: Dec. 21, 2006

(51) Int. Cl. G06F 9/44

(52) U.S. Cl. 717/124; 717/106

(57) ABSTRACT

A system includes a debugger in a processor-based system. The processor-based system further includes a module to serialize data associated with the debugger into an XML format. The system also includes a module to export the serialized data out of the debugger.

### TECHNICAL FIELD

Various examples relate to the field of debuggers in processor-based systems, and in an example, but not by way of limitation, the export and/or import of XML formatted data and/or source code generator output from and/or into a debugger.

### BACKGROUND

System analysis of computer and other processor-based systems is an involved and painstaking process. Such systems analyses may include system testing, unit and/or module testing, and performance analysis, just to name a few.

Whatever the analysis, test data is normally required for that analysis. The creation and maintenance of such test data and the expected output generated by that test data is not a trivial task. This is particularly true when a system comprises a multitude of modules or units, and each module requires a different format for its input data and produces its output data in a different format. This is further complicated when one is dealing with multiple systems, such as a production or customer system and a test or reference system. Such test data is normally painstakingly manually prepared, and as such, is susceptible to errors.

A debugger is a common way to analyze a system. A debugger can be used to set up break points in a software module, and along with other tools, the software module can be analyzed, debugged, and diagnosed. However, the use of a debugger is not always convenient on a production software system. Moreover, errors and other problems on a production system may be caused by data that does not exist on a test or reference system. Additionally, if the production system includes a multitude of modules that deal with a multitude of data types, the variety of data types can become quite cumbersome and not conducive to data analysis. The result is that it is very difficult to use the data that caused a problem on one system (production) to conduct tests on another system (test system). The art is therefore in need of an alternative method of dealing with debuggers and other software tools on multiple systems.

### BRIEF DESCRIPTION OF THE DRAWINGS

FIG. 1 illustrates a flowchart of an example embodiment of a process to export data from a debugger.

FIG. 2 illustrates a flowchart of another example embodiment of a process to export data from a debugger.

FIG. 3 illustrates a flowchart of an example embodiment of a process to export source code and/or data structures from a debugger.

FIG. 4 illustrates a flowchart of another example embodiment of a process to export source code and/or data structures from a debugger.

FIG. 5 illustrates a block diagram of an example embodiment of a system to export data from a debugger and/or import data into a debugger.

FIG. 6 illustrates a block diagram of an example embodiment of a system to export source code and/or data structures from a debugger and import source code and/or data structures into a debugger.

FIG. 7 illustrates a block diagram of a system to serialize data in a debugger, export the serialized data out of a debugger, and import the serialized data into a debugger.

FIG. 8A illustrates a block diagram of a system to serialize data in a debugger and convert that serialized data into source code.

FIG. 8B illustrates a block diagram of another system to serialize data in a debugger and convert that serialized data into source code.

FIG. 9 illustrates a block diagram of a system to convert data in a debugger into source code.

FIG. 10 illustrates an example embodiment of a process to serialize data in a debugger and generate source code using debugger data.

FIG. 11 illustrates an example embodiment of a process to import XML formatted data into a debugger.

FIG. 12 is an example schematic illustrating example uses of XML formatted data from a debugger.

FIG. 13 illustrates another example embodiment of a process to import XML formatted data into a debugger.

FIG. 14 illustrates an example embodiment of a processor-based system upon which and in connection with which one or more examples of the present disclosure may operate.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. Flowcharts disclosed herein illustrating these functions and algorithms are not to be interpreted as limiting the functions and algorithms to the order of steps disclosed in the flowcharts, and the functions and algorithms may be performed with all or a portion of the steps outlined in a particular flowchart. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

In an embodiment, a system includes a debugger in a processor-based system. The processor-based system further includes a module to serialize data associated with the debugger into an XML format, and a module to deserialize the XML data associated with the debugger. The system also includes a module to export the serialized data out of the debugger, and a module to import XML data into the debugger, so that the imported XML data can be deserialized and processed in the processor-based system. The system may further include a module that generates source code from the data associated with the debugger. The generated coding creates the data associated with the debugger and can be exported from the debugger.

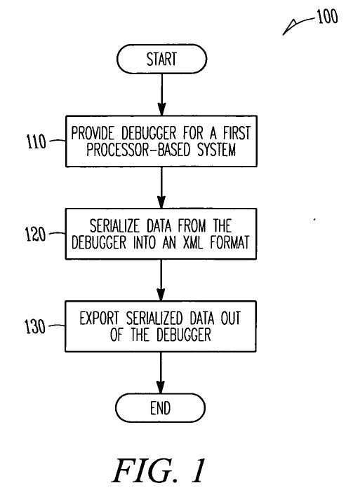

FIG. 1 illustrates a flow chart of an example embodiment of a process 100 to export data out of a debugger in a processor-based system. At 110, a debugger is provided for a first processor-based system. At 120, data that is associated with the debugger is serialized into an XML format. At 130, the data associated with the debugger that has been serialized into the XML format is exported out of the debugger. In at least one embodiment, since the data has been serialized into an XML format, it can be examined by a human without any further processing of that data.

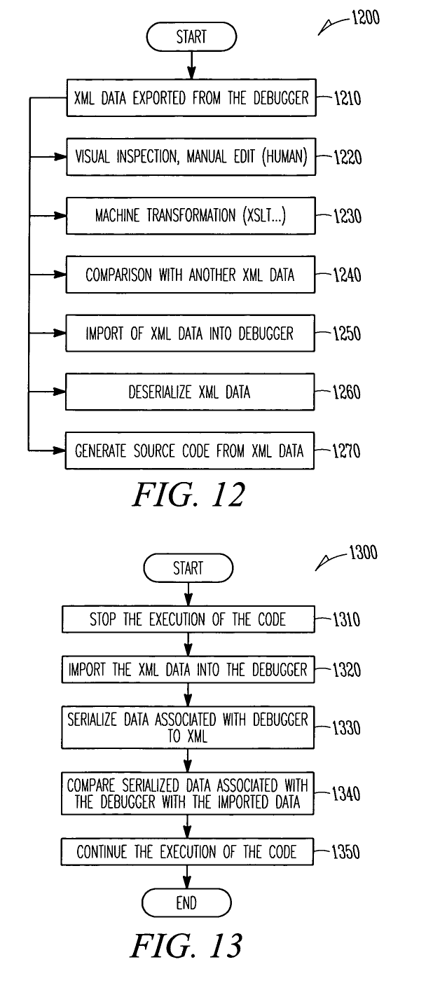

FIG. 12 is a schematic 1200 that illustrates several examples of the reuse of exported XML data. As indicated at 1210, XML data is exported from a debugger. At 1220, the XML data can be visually and/or manually inspected by a human. The XML data can further be collected in an XML repository. At 1230, the XML data may be inspected by a machine. For example, editing is possible using XSLT, and inspection is possible using XPath. At 1240, the XML data from the debugger may be compared with other XML data. This comparison may be performed with a comparison module based on an XML parser that processes two XML documents concurrently and outputs the detected differences between the two XML documents. The comparison may also be performed with a comparison module based on an XML change detection algorithm. At 1250, the XML data exported from the debugger may be imported into the same debugger or a different debugger. After import into the debugger, the XML data is deserialized, and may be used for error reproduction, testing analysis, diagnostics, and other purposes. At 1260, the XML data may be deserialized, and used in the same system or another system for error reproduction, unit testing, general testing, diagnostics, and other purposes. At 1270, source code may be generated from the XML data from the debugger. The exported XML data are input into a source code generator, and the source code generator generates the source code from the XML data. The generated code then can create deserialized XML data, and this data can be used for unit testing, error reproduction, general testing, diagnostics, and other purposes. FIG. 12 illustrates only a few examples of the reuse of exported XML data. Those of skill in the art will realize other uses and reuses of such exported XML data.

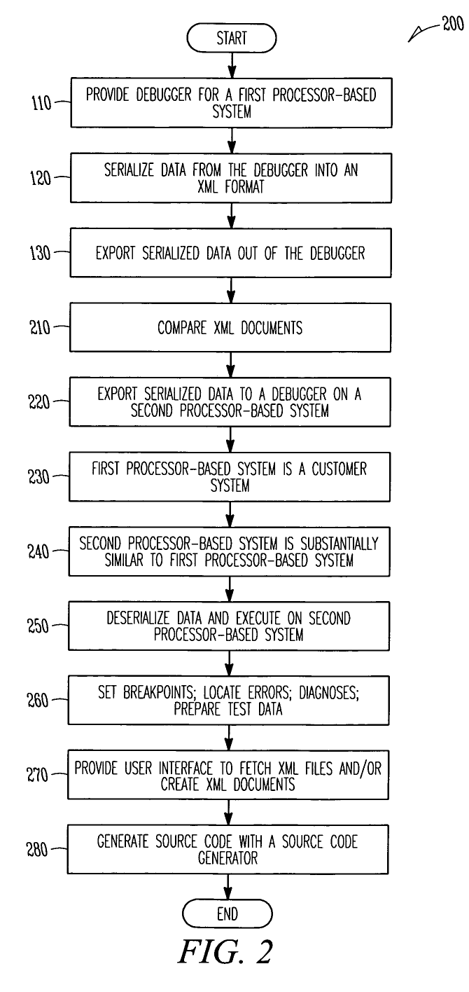

FIG. 2 illustrates a flow chart of another example embodiment of a process 200 to export data out of a debugger in a processor-based system. FIG. 2 illustrates that the process 200 includes steps 110, 120, and 130 of process 100, plus additional process steps. Specifically, operation 210 involves the comparison of XML documents. In this manner, the serialized debugger data may more easily be compared with other data.

At 220, the serialized data from the debugger in the first processor-based system is exported to a debugger associated with a second processor-based system. In an embodiment, the receipt of the data into the debugger in the second processor-based system is referred to as an import of the data into the debugger in the second processor-based system.

At 230, the first processor-based system is that of a customer and the second processor-based system is that of a software provider, and at 240, the second processor-based system is substantially similar to the first processor-based system. The relationship between the first processor-based system and second processor-based system at operations 230 and 240 may be referred to as a production system and test system respectively.

At 250, the data from the first processor-based system is deserialized, and it is then used in an execution of the second processor-based system. One aspect of operation 250 is that if the data caused an error on the first processor based system, that same data, after serialization and deserialization, can be used as test data on the second processor-based system. By using the data from the first processor-based system in testing on the second processor-based system, the difficult step of test data preparation is avoided. At 260, the execution of the second processor-based system using the deserialized data from the first processor-based system includes one or more of setting breakpoints in the debugger associated with the second processor-based system, locating an error in one or more of the first processor-based system and the second processor-based system, diagnosing one or more of the first processor-based system and the second processor-based system, and preparing test data.

At 270, a user interface is provided. The user interface has access to a plurality of XML-formatted data files. A user can then select an XML-formatted file to import into the debugger of the first processor-based system or the debugger of the second processor-based system. This allows a user to create an XML file for testing on either or both of the first processor-based system and the second processor-based system. Additionally at 270, the user interface provides a form in which a user may enter XML formatted data for import into the debugger of the first processor-based system or the debugger of the second processor-based system, thereby providing another manner in which the user may create XML data for use in connection with a debugger or other system analysis.

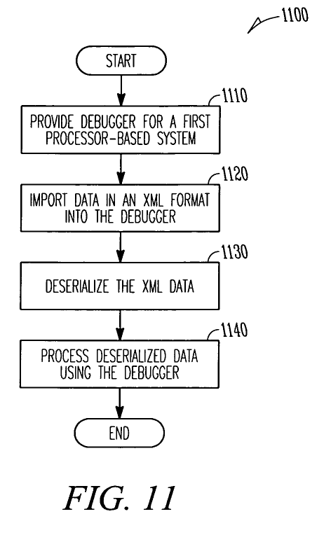

FIG. 11 illustrates an example embodiment of a process 1100 for import of data into a debugger. At 1110, a debugger is provided for a first processor-based system. At 1120, XML data is imported into the debugger. At 1130, the XML data is deserialized, and at 1140, the deserialized data is processed using the debugger. The XML data imported into the debugger may originate from a debugger in another processor-based system, a file created by an editor, or virtually any other source of XML data.

At 280, the data associated with the debugger in the first processor-based system includes source code generated by a source code generator. This generated source code can then be used in several ways. For example, the source code may be incorporated into a program module on a second processor-based system, such as a test system, and unit and other tests may be conducted on the second processor-based system using the module with the source code generated by the source code generator on the first processor-based system.

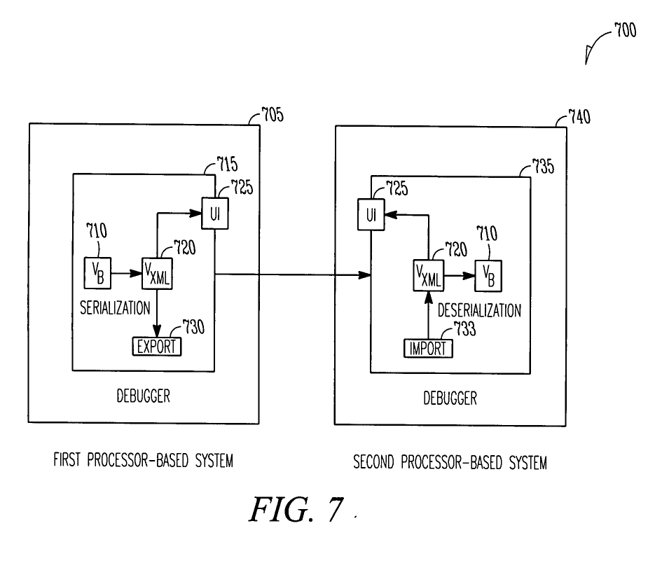

FIG. 7 illustrates in block diagram form a system 700 to export data from a debugger. In FIG. 7, a first processor-based system 705 includes data 710. Associated with the first processor-based system 705 is a debugger 715. The debugger 715 receives the data 710, and serializes it into an XML form 720. The XML data can be viewed via user interface 725, or exported via a module 730 to a debugger 735. Debugger 735 can be a debugger on another system, or it can be the same debugger on the same system. The debugger 735 receives the XML data 720 via an import module 733, and deserializes the data. The data 710 can then be processed on a second processor-based system 740. In an embodiment, the second processor-based system is the same system as the first processor-based system.

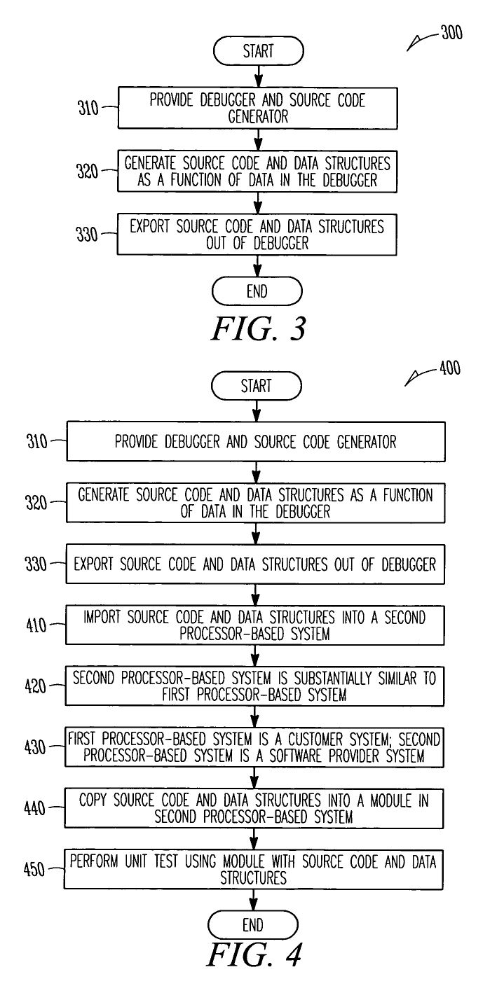

FIG. 3 illustrates a flow chart of another example embodiment of a process 300 to export data out of a debugger in a processor-based system. In the process 300 of FIG. 3, the data exported by the debugger is source code generated by a source code generator associated with the debugger. At 310, a debugger and a source code generator are provided for a first processor-based system. At 320, the source code generator is used to generate source code and data structures as a function of data associated with the debugger. At 330, the source code and data structures are exported out of the debugger associated with the first processor-based system.

FIG. 4 illustrates a flow chart of another example embodiment of a process 400 to export data out of a debugger in a processor-based system. The process 400 of FIG. 4 includes the steps 310, 320, and 330 of FIG. 3, plus additional process steps. Specifically, at 410, the source code and data structures generated by the source code generator are exported to a second processor-based system. At 420, the first processor-based system is substantially similar to the second processor-based system. At 430, the first processor-based system is that of a customer and the second processor-based system is that of a software provider.

At 440, one or more of the source code and data structures are copied into a module in the second processor based system. At 450, the module in the second processor-based system is used in a unit test or other diagnosis and/or analysis on the second processor-based system.

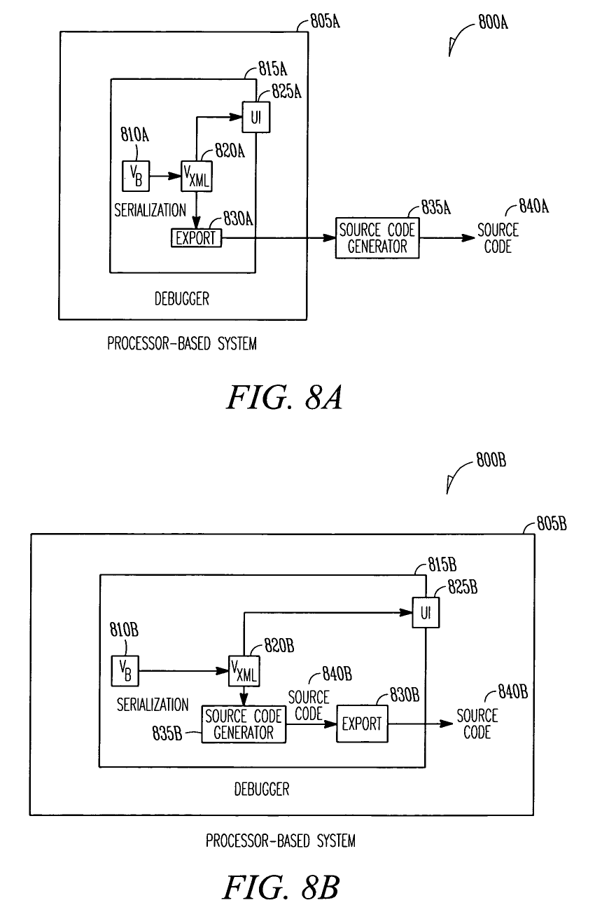

FIG. 8A illustrates a system 800A that exports source code and/or data structures from a debugger. In FIG. 8A, a processor-based system 805A includes data 810A. Associated with the processor-based system 805A is a debugger 815A. The debugger 815A takes the data 810A and serializes it into an XML format 820A. The XML formatted data can be viewed by a user interface 825A, and/or exported out of the debugger 815A via an export module 830A. The XML formatted data is then converted by a source code generator 835A into source code 840A.

FIG. 8B illustrates another embodiment of a system 800B that exports source code and/or data structures from a debugger. In FIG. 8B, a processor-based system 805B includes data 810B. Associated with the processor-based system 805B is a debugger 815B. The debugger 815B takes the data 810B and serializes it into an XML format 820B. The XML formatted data can be viewed by a user interface 825B, and/or converted into source code 840B by a source code generator 835B. The source code 840B may then be exported out of the debugger 815B via an export module 830A.

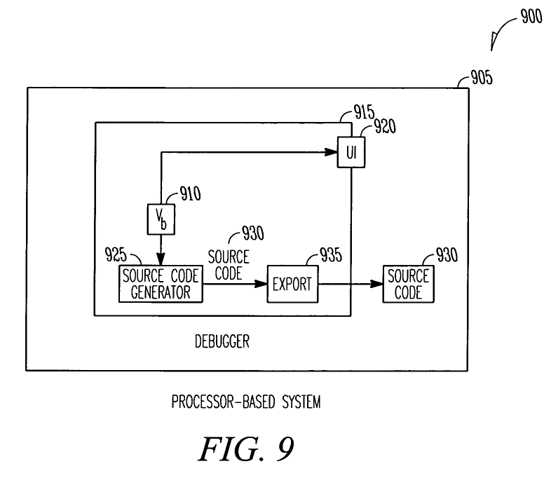

FIG. 9 illustrates yet another embodiment of a system 900 that exports source code and/or data structures from a debugger. The system 900 includes a processor-based system 905, which includes data 910. Associated with the processor-based system 905 is a debugger 915. The data 910 may be viewed via a user interface 920. A source code generator 925 may convert the data 910 into source code 930, and the source code 930 can be exported out of the debugger 915 via an export module 935.

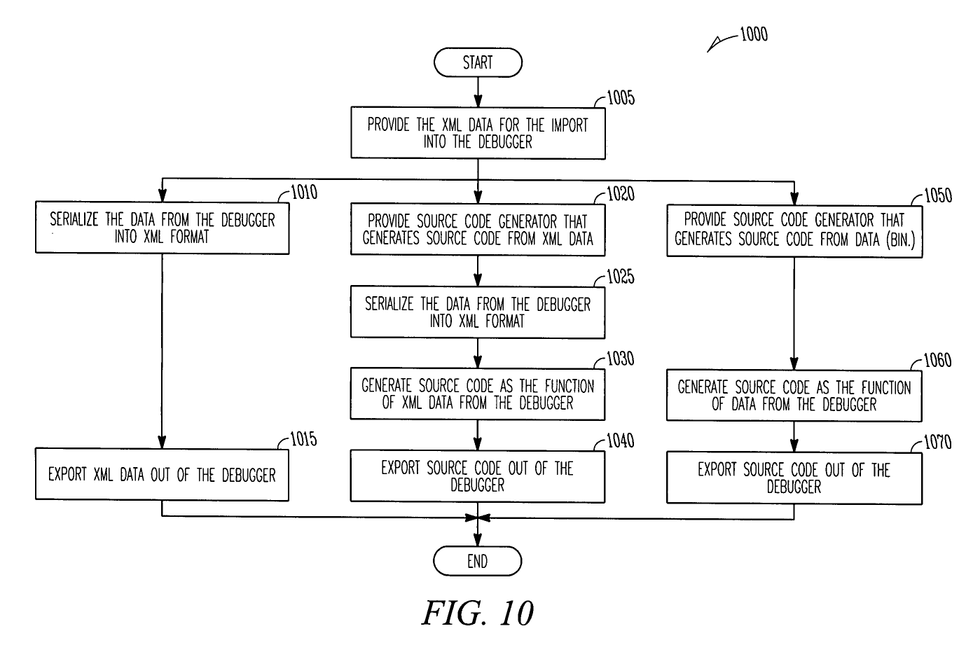

FIG. 10 illustrates another embodiment of a process 1000 that exports XML data out of a debugger and imports XML data into a debugger. Process 1000 of FIG. 10 includes many of the elements of FIGS. 1, 3, and 9. At 1005, XML data is provided for import into a debugger. At 1010, data from the debugger is serialized into an XML format. At 1015, the serialized XML data from the debugger is exported out of the debugger. At 1020, a source code generator is provided that generates source code from XML data. At 1025, data from the debugger is serialized into an XML format. At 1030, source code is generated as a function of XML data from the debugger. At 1040, the source code is exported out of the debugger. At 1050, a source code generator is provided that generates source code from binary data. At 1060, source code is generated as a function of data from the debugger. At 1070, the generated source code is exported out of the debugger.

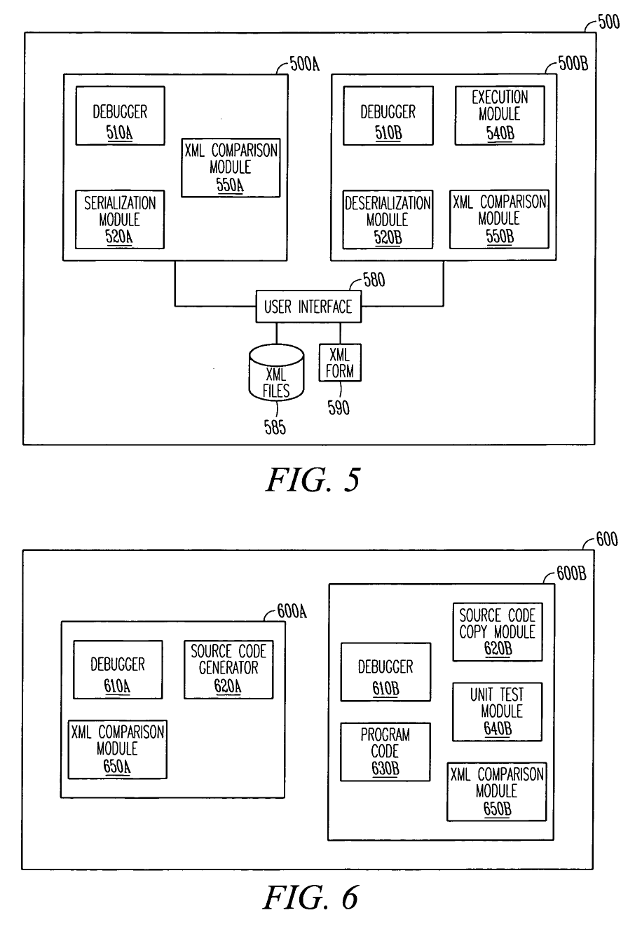

FIG. 5 illustrates a block diagram of a system 500 that can be used in connection with an export of data out of a debugger and the import of data into a debugger in a processor-based system. The system 500 includes a debugger 510A associated with a first processor-based system 500A. The debugger 510A is capable of exporting serialized XML data and importing serialized XML data. The system 500A includes a module 520A to serialize data that is associated with the debugger 510A into an XML format. The system 500A further includes an XML comparison module 550A.

The system 500 further includes a debugger 510B that is associated with a second processor-based system 500B. The debugger 510B that is associated with the second processor-based system is configured to import data that is exported by the debugger 510A in the first processor-based system. A module 520B is configured to deserialize the data from the first processor-based system 500A. Another module 540B is configured to execute the second processor-based system 500B using the deserialized data from the first processor-based system 500A. The system 500B further includes an XML comparison module 550B. In an embodiment, the first processor-based system 500A and the second processor-based system 500B are the same system.

FIG. 5 further illustrates that the system 500 may include a user interface 580. The user interface has access to a plurality of XML-formatted data files 585. Using the user interface 580, a user can select an XML-formatted file to import into the debugger 510A of the first processor-based system or the debugger 510B of the second processor-based system. The user interface provides a form 590 in which a user may enter XML formatted data for import into the debugger 510A of the first processor-based system 500A or the debugger 510B of the second processor-based system 500B.

FIG. 6 illustrates a block diagram of a system 600 that can be used in connection with an export of source code and/or data structures out of a debugger in a processor-based system and/or the import of source code and/or data structures into a debugger in a processor-based system. Specifically, FIG. 6 illustrates a system 600A that includes a debugger 610A and a source code generator 620A. The debugger 610A is capable of exporting serialized XML data and importing serialized XML data. In an embodiment, the source code generator is configured to generate source code and data structures as a function of data associated with the debugger 610A. The system 600A further includes an XML comparison module 650A.

FIG. 6 further illustrates that the system 600 may include a system 600B that includes a debugger 610B. The debugger 610B is configured to import the source code from the first processor-based system 600A. The system 600B further includes a module 620B that is configured to copy one or more of the source code and the data structures into program code 630B in the second processor-based system 600B. A module 640B is configured to use the program code in the second processor-based system 600B in a unit test on the second processor-based system 600B. The system 600B further includes an XML comparison module 650B. In an embodiment, the first processor-based system 600A and the second processor-based system 600B are the same system.

FIG. 13 illustrates another embodiment of a process 1300 relating to a debugger and the use of XML data in connection with the debugger. At 1310, a debugger is employed to stop the execution of a program or process. At 1320, XML data is imported into the debugger. This XML data can originate from any source, including a separate system, a previous execution of the same system, a test system, and/or a file credited with an editor, just to name a few sources. At 1330, data that is associated with the debugger is serialized into an XML format. Then, at 1340, the imported XML data is compared with the serialized debugger data. After the comparison, analysis, and/or testing is complete, the execution of the program or process is continued at 1350.

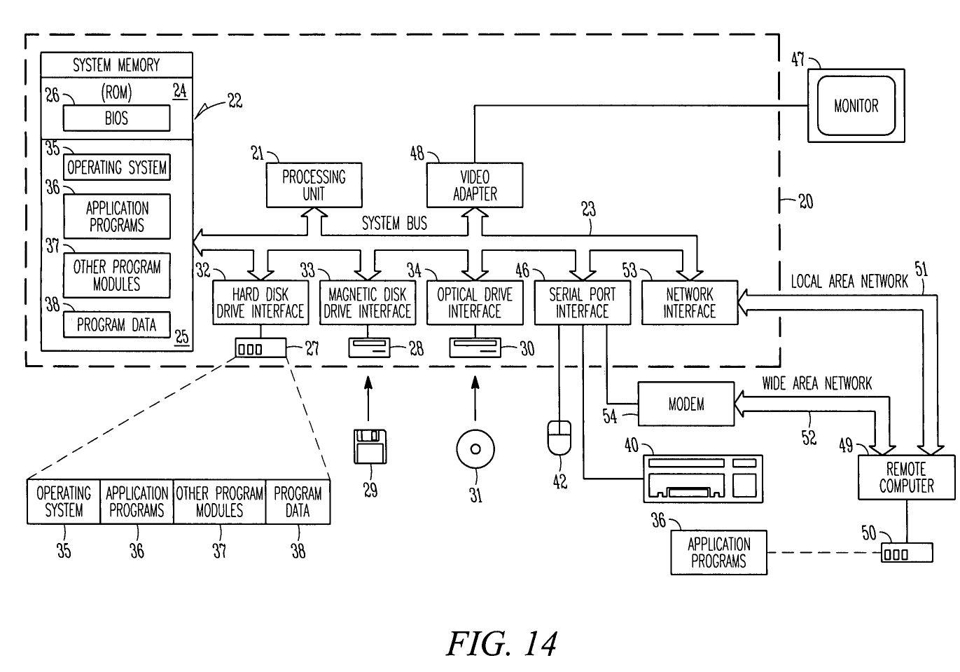

FIG. 14 is an overview diagram of a hardware and operating environment in conjunction with which embodiments of the disclosure may be practiced. The description of FIG. 14 is intended to provide a brief, general description of suitable computer hardware and a suitable computing environment in conjunction with which the disclosure may be implemented. In some embodiments, the examples of the disclosure are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the examples of the disclosure may be practiced with other computer system configurations, including hand-held devices, multiprocessor systems, microprocessor-based or programmable consumer electronics, network PCS, minicomputers, mainframe computers, and the like. The examples of the disclosure may also be practiced in distributed computer environments where tasks are performed by I/0 remote processing devices that are linked through a communications network. In a distributed computing environment, program modules may be located in both local and remote memory storage devices.

In the embodiment shown in FIG. 14, a hardware and operating environment is provided that is applicable to any of the servers and/or remote clients shown in the other Figures.

As shown in FIG. 14, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the examples in the disclosure are not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 14 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

In the foregoing detailed description, various features are grouped together in one or more examples or examples for the purpose of streamlining the disclosure. This method of disclosure is not to be interpreted as reflecting an intention that the claimed examples of the invention require more features than are expressly recited in each claim. Rather, as the following claims reflect, inventive subject matter lies in less than all features of a single disclosed example. Thus the following claims are hereby incorporated into the detailed description of examples of the invention, with each claim standing on its own as a separate example. It is understood that the above description is intended to be illustrative, and not restrictive. It is intended to cover all alternatives, modifications and equivalents as may be included within the scope of the invention as defined in the appended claims. Many other examples will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A method comprising:
providing a debugger for a first processor-based system;
serializing data associated with the debugger into an XML format; and
exporting the serialized data out of the debugger.

2. The method of claim 1, wherein the data is compared with other XML data using a module including one or more of an XML parser and an XML change detection algorithm.

3. The method of claim 1, wherein the serialized data from the debugger in the first processor-based system is exported to a debugger associated with a second processor-based system.

4. The method of claim 3, wherein the first processor-based system is that of a customer and the second processor-based system is that of a software provider.

5. The method of claim 3, wherein the second processor-based system is substantially similar to the first processor-based system.

6. The method of claim 3, wherein the second processor-based system includes one or more of the first processor-based system and a processor-based system separate from the first processor-based system.

7. The method of claim 6, further comprising:
deserializing the data from the first processor-based system; and
executing the second processor-based system using the deserialized data from the first processor-based system.

8. The method of claim 7, wherein the execution of the second processor-based system using the deserialized data from the first processor-based system includes one or more of setting breakpoints in the debugger associated with the second processor-based system, locating an error in one or more of the first processor-based system and the second processor-based system, diagnosing one or more of the first processor-based system and the second processor-based system, and preparing test data.

9. The method of claim 6, further comprising providing a user interface, the user interface having access to a plurality of XML-formatted data files, so that a user can select an XML-formatted file to import into one or more of the debugger of the first processor-based system and the debugger of the second processor-based system.

10. The method of claim 9, wherein the user interface provides a form in which a user may enter XML formatted data for import into one or more of the debugger of the first processor-based system and the debugger of the second processor-based system.

11. The method of claim 1, wherein the data associated with the debugger includes source code generated by a source code generator.

12. A method comprising:
providing a debugger and a source code generator for a first processor-based system;
using the source code generator to generate source code and data structures as a function of data associated with the debugger; and
exporting the source code and data structures out of the debugger of the first processor-based system.

13. The method of claim 12, wherein the source code and data structures are exported to a second processor-based system.

14. The method of claim 13, wherein the second processor-based system includes one or more of the first processor-based system and a processor-based system separate from the first processor-based system.

15. The method of claim 14, wherein the first processor-based system is substantially similar to the second processor-based system.

16. The method of claim 13, wherein the first processor-based system is that of a customer and the second processor-based system is that of a software provider.

17. The method of claim 14, further comprising:
copying one or more of the source code and data structures into a module in the second processor based system; and
using the module in the second processor-based system in a unit test on the second processor-based system.

18. A system comprising:
a debugger in a first processor-based system;
a module to serialize data associated with the debugger into an XML format; and
a module to export the serialized data out of the debugger.

19. The system of claim 18, further comprising:
a debugger associated with a second processor-based system, the debugger associated with the second processor-based system configured to import data exported by the debugger in the first processor-based system;
a module to deserialize the data from the first processor-based system; and
a module to execute the second processor-based system using the deserialized data from the first processor-based system;
wherein the second processor-based system includes one or more of the first processor-based system and a processor-based system separate from the first processor-based system.

20. The system of claim 19, further comprising:
a user interface, the user interface having access to a plurality of XML-formatted data files, so that a user can select an XML-formatted file to import into the debugger of the first processor-based system or the debugger of the second processor-based system;
wherein the user interface provides a form in which a user may enter XML formatted data for import into the debugger of one or more of the first processor-based system and the debugger of the second processor-based system.

21. A system comprising:
a debugger and a source code generator associated with a first processor-based system, the source code generator generating source code and data structures as a function of data associated with the debugger; and
a module to export the source code and data structures out of the debugger of the first processor-based system.

22. The system of claim 21, further comprising:
a debugger associated with a second processor-based system, the debugger associated with the second processor-based system importing the source code from the first processor-based system;
a module to copy one or more of the source code and data structures into program code in the second processor based system; and
a module to use the program code in the second processor-based system in a unit test on the second processor-based system;
wherein the second processor-based system includes one or more of the first processor-based system and a processor-based system separate from the first processor-based system.

23. A method comprising:
halting an execution of a computer-based process with a debugger;
importing XML data into the debugger;
serializing data associated with the debugger into an XML format;
comparing the imported XML data and the serialized debugger data; and
continuing execution of the process.

24. A system comprising:
a debugger;
a module to import XML data into the debugger;
a module to serialize data associated with the debugger into an XML format; and
a module to compare the XML data and the serialized debugger data.
